(19) United States
(12) Patent Application Publication
(10) Pub. No.: US 2025/0173235 A1
(43) Pub. Date: May 29, 2025

(54) SIGNAL PAIRING ANALYSIS METHOD

(71) Applicant: ZEROPLUS TECHNOLOGY CO., LTD., New Taipei City (TW)

(72) Inventor: CHIU-HAO CHENG, New Taipei City (TW)

(73) Assignee: ZEROPLUS TECHNOLOGY CO., LTD., New Taipei City (TW)

(21) Appl. No.: 18/963,533

(22) Filed: Nov. 28, 2024

Related U.S. Application Data
(60) Provisional application No. 63/604,164, filed on Nov. 29, 2023.

(30) Foreign Application Priority Data
Jun. 5, 2024 (TW) 113120875

(51) Int. Cl. G06F 11/30

(52) U.S. Cl. CPC G06F 11/3072; G06F 2201/84

(57) ABSTRACT

A signal pairing analysis method, including: loading a signal file to be analyzed, in which a plurality of input signals and a plurality of output signals captured from the device under test are recorded; setting a search condition for the input signals to be searched and a search condition for the output signals to be searched, and respectively generating an input signal search condition and an output signal search condition accordingly; searching among the output signals in the signal file to find first signals that match the output signal search condition based on the output signal search condition, and searching among the input signals in the signal file to find second signals that match the input signal search condition based on the input signal search condition; performing a pairing analysis step to analyze the plurality of first signals and second signals and generate a statistical result.

### BACKGROUND OF THE INVENTION

### Technical Field

The present invention relates generally to an analysis method, and more particularly to a signal pairing analysis method.

### Description of Related Art

When testing and analyzing performance or characteristics of a hardware or system, it is necessary to observe a relationship between input signals and output signals to understand whether the response time and performance of the hardware or system are regular and up to standard.

However, the prior arts do not provide a comprehensive set of signal analysis methods to efficiently and accurately evaluate the performance of the hardware or system. As a result, researchers encounter difficulties in further improving the characteristics of the hardware or system.

### BRIEF SUMMARY OF THE INVENTION

In view of the above, the primary objective of the present invention is to provide a signal pairing analysis method that allows a user to select a pairing condition for signals and find signal data that meets the pairing condition to generate a statistical result for the user to review.

The present invention provides a signal pairing analysis method for analyzing a device under test that receives an input signal and generates a corresponding output signal, comprising steps of:
loading, by an electronic device, a signal file to be analyzed, in which a plurality of input signals and a plurality of output signals captured from the device under test are recorded;
performing, by the electronic device, a setting step, including setting a search condition for the input signals to be searched and a search condition for the output signals to be searched, and respectively generating an input signal search condition and an output signal search condition accordingly;
performing, by the electronic device, a search step, including searching among the plurality of output signals in the signal file to find a plurality of first signals that match the output signal search condition based on the output signal search condition, and searching among the plurality of input signals in the signal file to find a plurality of second signals that match the input signal search condition based on the input signal search condition;
performing, by the electronic device, a pairing analysis step, including:
A1. when any of the plurality of first signals is found to be preceded by one corresponding second signal, recording a first time parameter between the first signal and the corresponding second signal thereof;
A2. at least analyzing the plurality of first signals, the plurality of second signals and the plurality of the first time parameters to generate a statistical result.

With the aforementioned design, the statistical results allow the user to review the status of the input signals and output signals for reliability and performance analysis.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a block diagram of an analysis system applied to a signal pairing analysis method according to a first embodiment of the present invention;

FIG. 2 is a flow chart of the signal pairing analysis method according to the first embodiment of the present invention;

FIG. 3 is a schematic view of a setting interface, illustrating selecting input signals and output signals as waveform signals;

FIG. 4 is a schematic view of a display interface, illustrating an input signal search condition and an output signal search condition selected by circling;

FIG. 5 is a schematic view of the setting interface, illustrating an input signal search condition selected and an output signal search condition selected;

FIG. 6 is a schematic view of pairing first signals with the second signals;

FIG. 7 is a flow chart of pairing steps;

FIG. 8 is a schematic view, illustrating that a packet loss is present when pairing the first signals with the second signals;

FIG. 9 is a schematic view of pairing the first signals with the second signals in another pairing way;

FIG. 10 is a flow chart of pairing steps of the another pairing way;

FIG. 11 is a schematic view of a display interface, illustrating a plurality of sets of pairing data after the pairing analysis steps;

FIG. 12 is a schematic view of a statistical result, illustrating distribution of time segments in response times;

FIG. 13 is a schematic view of the statistical result and a display interface, illustrating that the display interface displays a position of the output signal corresponding to one response time after clicking the response time;

FIG. 14 is a schematic view of a setting interface according to a second embodiment of the present invention, illustrating selecting the input signals and the output signals as bus packet signals;

FIG. 15 is a schematic view of a display interface according to a third embodiment of the present invention, illustrating the pairing data and the statistical results after the pairing analysis steps;

FIG. 16 is a schematic view of a display interface according to a fourth embodiment of the present invention, illustrating setting a plurality of pairing groups; and

FIG. 17 is a schematic view of a display interface according to a fifth embodiment of the present invention, illustrating selecting the input signals as the waveform signal and the output signals as the bus packet signal.

### DETAILED DESCRIPTION OF THE INVENTION

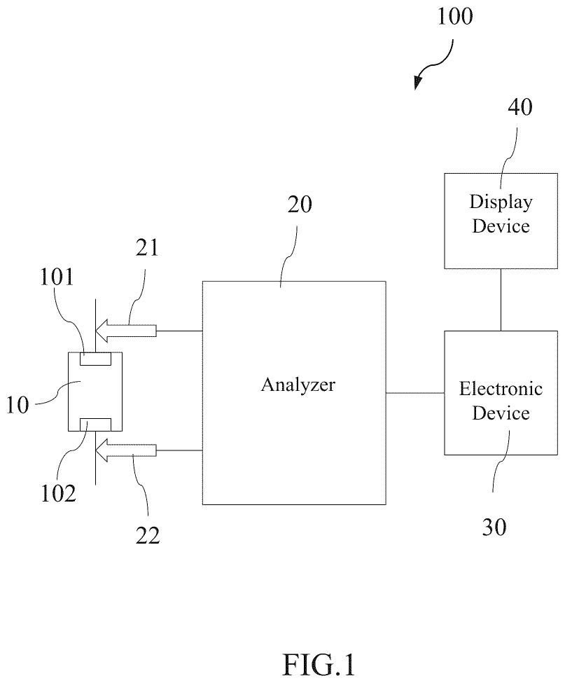

An analysis system 100 applied to a signal pairing analysis method according to a first embodiment of the present invention is illustrated in FIG. 1, wherein the analysis system 100 is for analyzing a device under test 10. In the current embodiment, the device under test 10 is quality inspection equipment in a production line of a factory as an example, including an input terminal 101 for receiving an input signal and an output terminal 102 for outputting an output signal corresponding to the input signal. For example, in the current embodiment, the input terminal 101 could be connected to an image capture module (not shown) to capture a series of images of products under test continuously, and the quality inspection equipment is for comparing the image of each product with a built-in standard image to determine whether each product is good or defective and to output inspection results through the output terminal 102.

The analysis system 100 includes an analyzer 20, an electronic device 30, and a display device 40. The analyzer 20 is used to read or capture data of the device under test 10 and generate a signal file to be analyzed, the signal file recording a plurality of input signals and a plurality of output signals captured from the device under test 10. The electronic device 30 connected to the analyzer 20 is configured to receive and analyze the signal file. The display device 40 connected to the electronic device 30 is configured to display the input signals and output signals in the signal file.

In the current embodiment, the analyzer 20 is a logic analyzer as an example, including two probe sets 21, 22 electrically connected to the input terminal 101 and the output terminal 102 of the device under test 10, respectively. The probe set 21 is used to capture the input signals received by the input terminal 101, for example, in the current embodiment, to capture image signals transmitted by the image capture module; the probe set 22 is used to capture the output signals output by the output terminal 102, for example, in the current embodiment, to capture inspection results from the quality inspection equipment, wherein the input signals and output signals are digital signals. In this way, the logic analyzer could integrate the captured and collected input signals and output signals into a signal file and output the signal file, wherein the signal file includes a time sequence of the input signals and output signals captured. Additionally, in other embodiments, a specific analyzer could be selected based on a device or signal under test, not limited to the logic analyzer.

In the current embodiment, the electronic device 30 is exemplified by a computer host that could be connected to the logic analyzer via either a wired or wireless connection to receive the signal file output by the logic analyzer, to store the signal file on a storage medium, such as a hard disk, and to analyze the signal file. The electronic device 30 could also search among the plurality of output signals to find corresponding first signals based on the search conditions selected and search among the plurality of input signals to find corresponding second signals, thereby analyzing the relationship and time sequence between the first signals and the second signals to generate a statistical result. In other embodiments, the electronic device 30 could also be a device with computing ability, such as a computer, a workstation, or a server, not limited to a computer host.

The display device 40 could be a display, such as a computer monitor. In an embodiment, the display device 40 could also be a mobile device or an electronic device other than the electronic device 30, which could be connected to the electronic device 30 via either a wired or wireless connection to receive the signal file and the statistical result and to display them on a display interface, wherein the display device 40 could be a local or remote device relative to the electronic device 30.

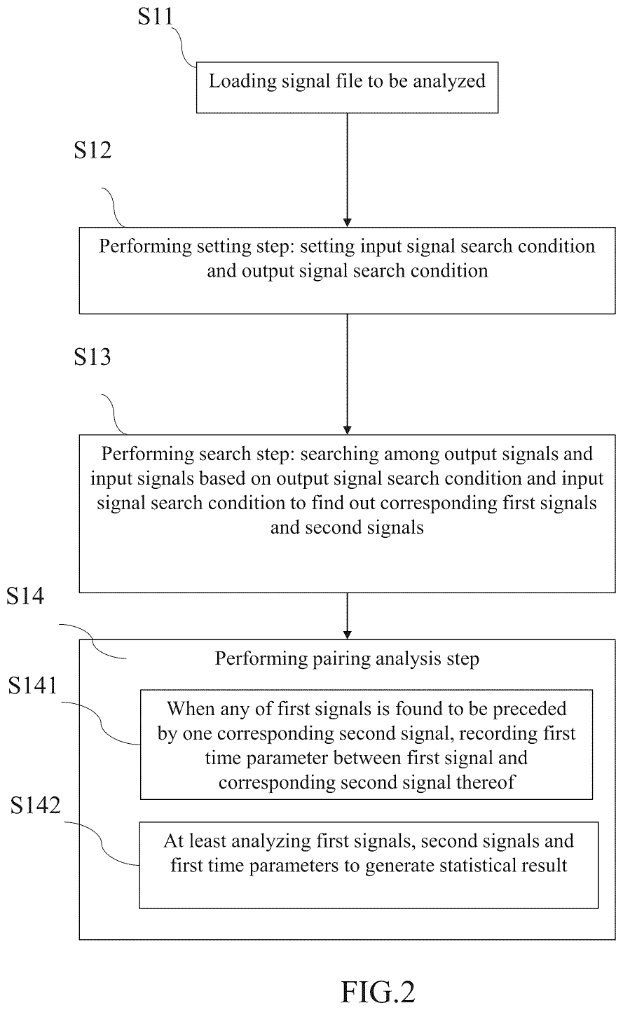

As shown in FIG. 2, the signal pairing analysis method of the present invention mainly includes the following steps.

Step S11: loading, by the electronic device 30, the signal file to be analyzed, in which a plurality of input signals and a plurality of output signals captured from the device under test 10 are recorded. The signal file includes a position of each input signal in the time sequence and a position of each output signal in the time sequence. For example, in the current embodiment, the electronic device 30 loads the signal file from a storage medium. Each position in the time sequence could be a time point that represents a timestamp.

Step S12: performing, by the electronic device 30, a setting step, including setting a search condition for the input signals to be searched and a search condition for the output signals to be searched, and respectively generating an input signal search condition and an output signal search accordingly.

Step S13: performing, by the electronic device 30, a search step, including searching and comparing among the plurality of output signals in the signal file to find a plurality of first signals that match the output signal search condition based on the output signal search condition, and searching and comparing among the plurality of input signals in the signal file to find a plurality of second signals that match the input signal search condition based on the input signal search condition. Additionally, in the search step, the electronic device 30 could search for either the first signals or the second signals first. The terms “first” and “second” in reference to the first signals and second signals are only used to distinguish between the first signal, which is an output signal, and the second signal, which is an input signal; the terms do not imply any specific order of searching.

Step S14: performing, by the electronic device 30, a pairing analysis step, including step S141 (pairing step) and step S142 (analyzing step).

Step S141: when any of the plurality of first signals is found to be preceded by one corresponding second signal, recording a first time parameter between the first signal and the corresponding second signal thereof. In the current embodiment, when any of the plurality of first signals is not found to be preceded by one corresponding second signal, recording it as a packet loss and recording a second time parameter corresponding to the packet loss.

Step S142: at least analyzing the plurality of first signals, the plurality of second signals, and the plurality of first time parameters to generate a statistical result. In the current embodiment, the electronic device 30 analyzes the plurality of first signals, the plurality of second signals, the plurality of first time parameters, and the plurality of second time parameters to generate the statistical result.

In the setting step of step S12, the user could select the input signals and the output signals that could reflect the performance or reliability of the device under test 10. In an embodiment, the user could use a program to find signals under specific conditions for analysis based on the type of bus to which the probe sets 21, 22 are connected. Also, in an embodiment, the user could customize a specific waveform for the input signal and a specific waveform for the output signal as the input search condition and the output search condition.

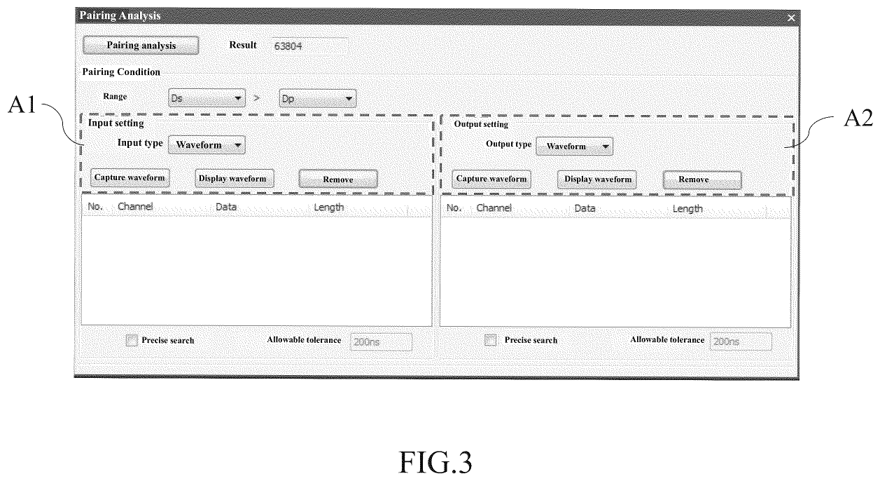

In the current embodiment, the types of the input signals and output signals include waveform signals and bus packet signals, and the user could customize the type of the input signals and the type of the output signals before analyzing. For example, as shown in FIG. 3, in an input setting area A1 of a user interface displayed on the display device 40, the user could select the input type of the input signals (e.g., waveform signals or bus packet signals) while in an output setting area A2, the user could select the output type of the output signals (e.g., waveform signals or bus packet signals). The user could arbitrarily arrange the input type of the input signals and the output type of the output signals, for example, the input type is the input waveform signal and the output type is the output waveform signal (i.e., the type of the input signals is the waveform signal and the type of the output signals is the waveform signal), the input type is the bus packet signal and the output type is the bus packet signal, the input type is the waveform signal and the output type is the bus packet signal, or the input type is the bus packet signal and the output type is the waveform signal.

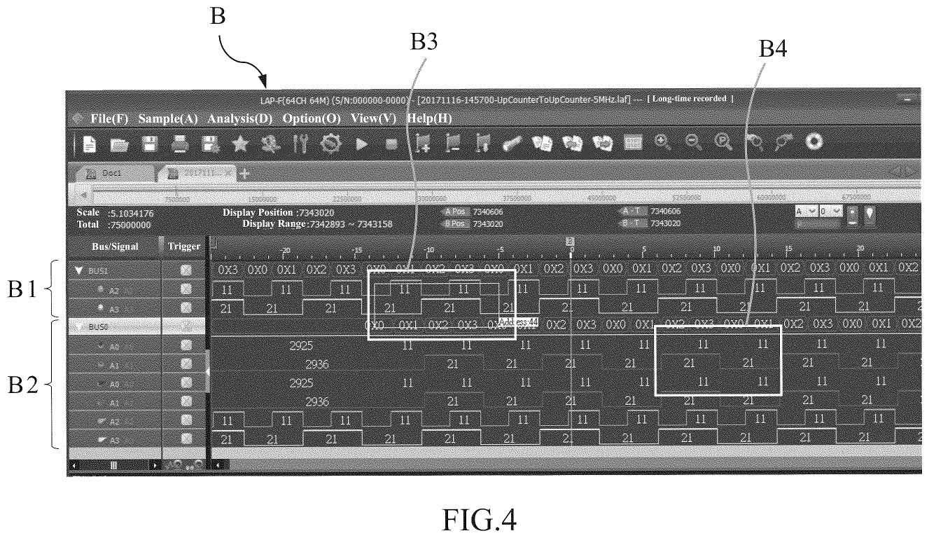

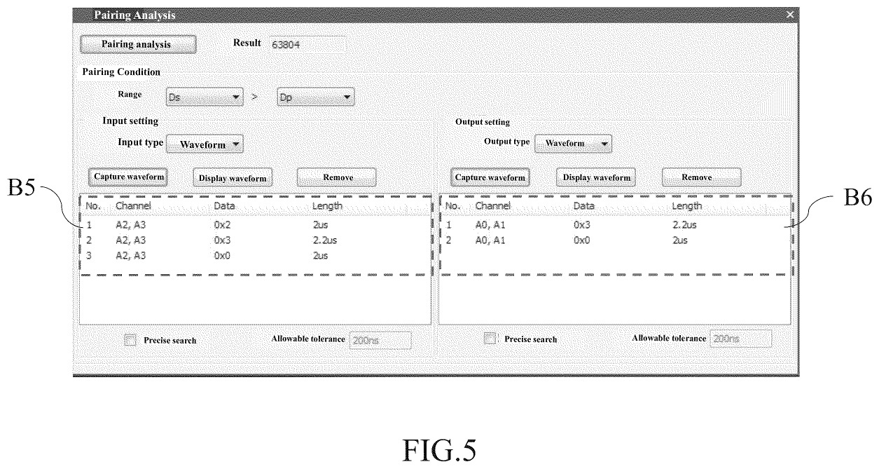

For example, when the user selects a type of waveform signals, the user could access a display interface to capture the waveform. In the current embodiment, after the user clicks the “Capture waveform”, the electronic device 30 would guide the user into a display interface B, shown in FIG. 4. The data of two buses B1, B2 are displayed on the display interface B, wherein the bus B1 has two channels, each indicating one input signal, and the bus B2 has six channels, each indicating one output signal. The user could circle a selected range on the display interface by controlling a cursor, thereby setting a signal segment in the selected range as the input signal search condition or the output signal search condition; for example, as shown in FIG. 4, setting the signal segment circled in the selected range B3 as the input signal search condition and setting the signal segment circled in the selected range B4 as the output signal search condition. As shown in FIG. 5, the electronic device 30 would interpret the selected range B3 and the selected range B4 selected by the user, and respectively generate and list the input signal search condition B5 and the output signal search condition B6 set in the selected range B3 and the selected range B4, thereby saving the user's time for setting the input signal search condition B5 and the output signal search condition B6.

After the input signal search condition B5 and the output signal search condition B6 are confirmed to be correct, the electronic device 30 could proceed to the search step of step S13.

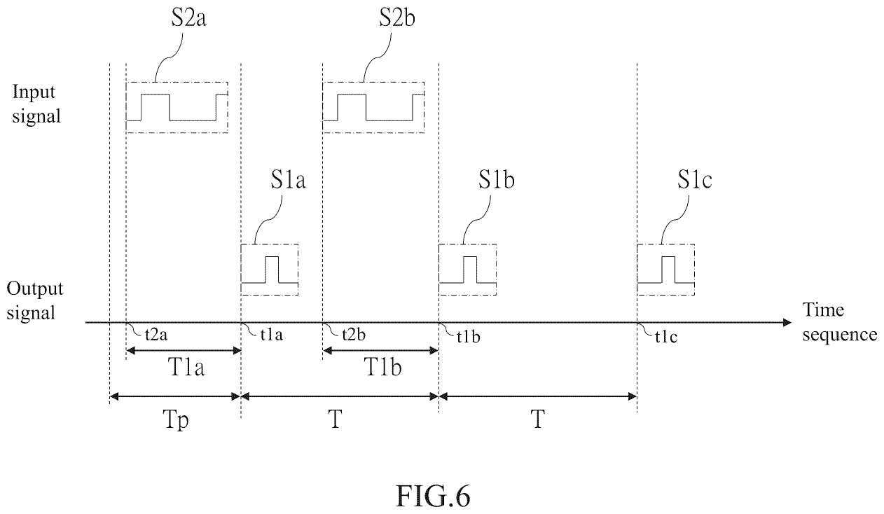

In the search step of step S13, the second signals S2a, S2b and the first signals S1a, S1b, S1c could be found respectively as shown in FIG. 6 based on the input signal search condition B5 and the output signal search condition B6. Then, the electronic device 30 could proceed to the pairing analysis step of step S14.

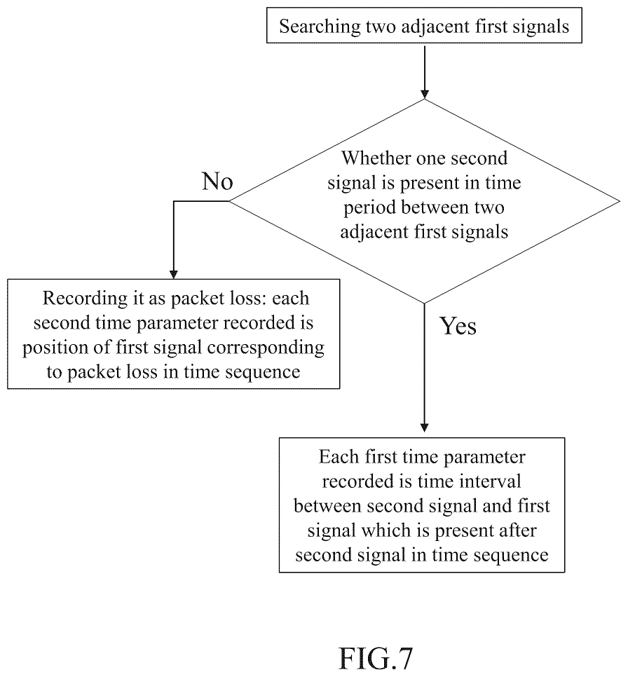

As shown in FIG. 6 and FIG. 7, the specific steps provided in the current embodiment to carry out step S141 are as follows: searching whether one second signal is present in a time period T between two adjacent first signals; if so, the first time parameter recorded is a time interval (or known as time difference, or response time) between the second signal and the first signal, which is present after the second signal in a time sequence; if not, the second time parameter recorded is a position of the first signal corresponding to the packet loss in the time sequence. For example, as shown in FIG. 6, one second signal S2b is present between the two consecutive adjacent first signals S1a, S1b in the time sequence, and a time interval T1b between the second signal S2b and the first signal S1b, which is present later in the time sequence, is recorded to form the first time parameter. In the current embodiment, the time interval T1b is a time difference between a time point t1b, where the first signal S1b is present, and a time point t2b, where the second signal S2b is present. In addition, when one second signal corresponding to the first signal S1c is not present in the time period T between the two adjacent first signals S1b, S1c, recording it as a packet loss and recording a position of the first signal S1c in the time sequence (i.e., time point t1c) to form the second time parameter. And, a relationship could be further established with respect to the packet loss to determine a correlation between the packet loss and the first signal S1c. The packet loss indicates the occurrence of an error; for example, there could be a signal line poorly connected, the device under test 10 is unstable, or the device under test 10 has a fault, such that no second signal precedes a part of the first signals, such as the first signal S1c, in the time sequence.

For the first signal S1a, which is the first among the first signals in the time sequence, searching whether one second signal S2a (i.e., the first among the second signals in the time sequence) is present in a predetermined time period Tp before the first signal S1a; if so, recording a time interval T1a between the first signal S1a, which is the first among the first signals in the time sequence, and the corresponding second signal S2a to form the first time parameter; if not, recording it as a packet loss and recording a position of the first signal S1a in the time sequence (i.e., time point t1a) to form the second time parameter. And, a relationship could be further established with respect to the packet loss to determine a correlation between the packet loss and the first signal S1a. In the current embodiment, the time interval T1a could be a time difference between a time point t1a, where the first signal S1a is present, and a time point t2a, where the second signal S2b is present, but it is not limited thereto. The user could customize a start reference time point and an end reference time point of a time interval; for example, the start reference time point is a first rising edge of the waveform of the second signal S2a while the end reference time point is a last falling edge of the waveform of the first signal S1a, and the time interval is the time difference between the start reference time point and the end reference time point. Preferably, the setting step of step S12 could include setting the start reference time point of an input signal to be searched for and the end reference time point of an output signal to be searched for, so that the electronic device 30 could utilize the above information in step S141.

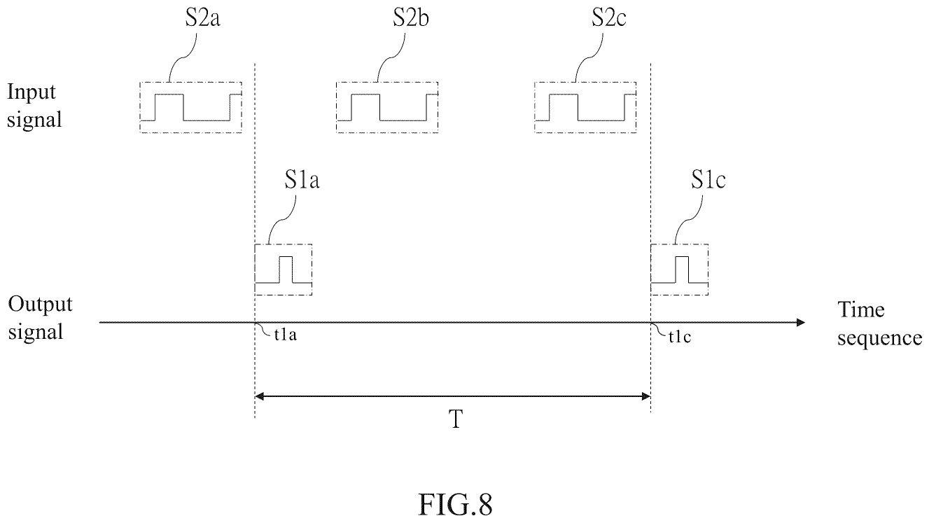

Additionally, in step S141 as shown in FIG. 8, when two or more second signals S2b, S2c are found in the time period T between the two adjacent first signals S1a, S1c, recording it as an output packet loss and recording a third time parameter corresponding to the output packet loss. The third time parameter is the position of the first signal S1c in the time sequence (i.e., time point t1c), where the first signal S1c is the later one of the two adjacent first signals S1a, S1c. And, a relationship could be further established with respect to the output packet loss to determine a correlation between the output packet loss and the first signal S1c. In an embodiment, it is also possible to form the third time parameter with the position of the first signal S1a in the time sequence (i.e., time point t1a), where the first signal S1a is the front one of the two adjacent first signals S1a, S1c, and to establish the relationship.

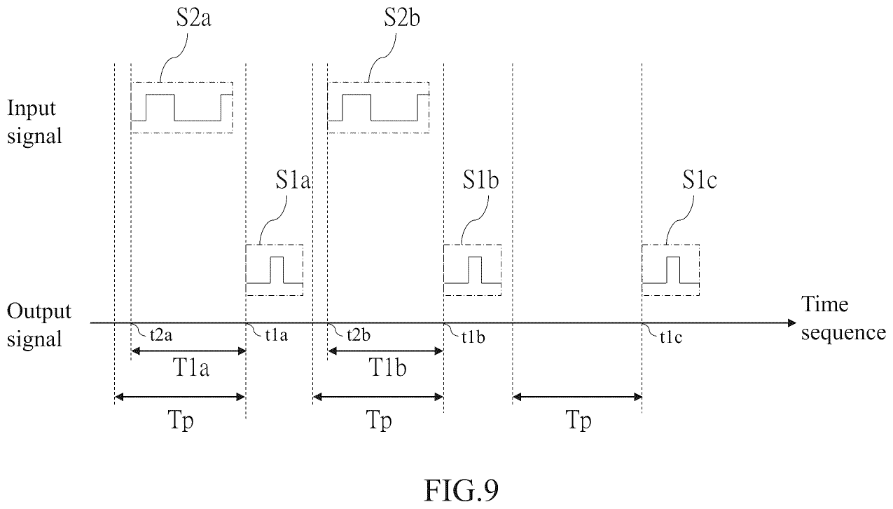

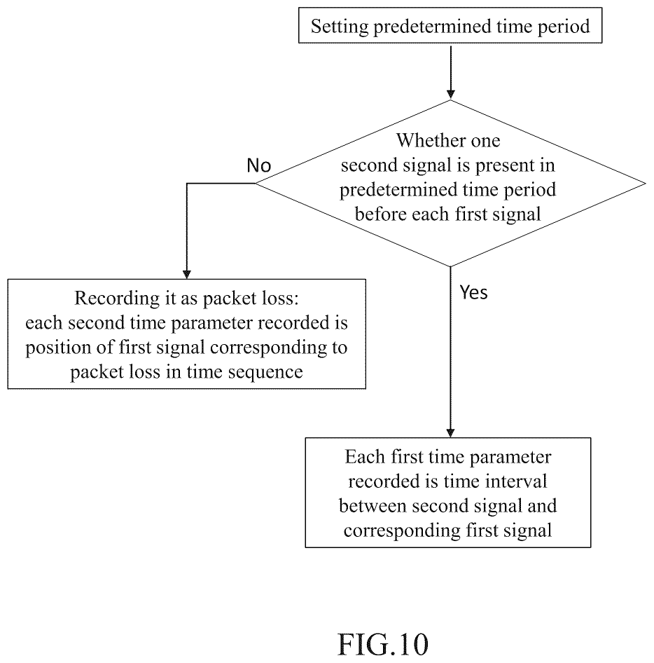

In addition, as shown in FIG. 9 and FIG. 10, another specific steps to carry out step S141 are as follows: searching whether one second signal is present in a predetermined time period Tp before each of the first signals; if so, the first time parameter recorded is a time interval (or known as time difference, or response time) between the second signal and the corresponding first signal; if not, the second time parameter recorded is a position of the first signal corresponding to the packet loss in the time sequence. For example, as shown in FIG. 9, the second signal S2a is present in the predetermined time period Tp before the first signal S1a, so that the time interval T1a between the first signal

S1a and the second signal S2a is recorded to form the first time parameter, i.e., the time difference between the time point t1a, where the first signal S1a is present, and the time point t2a, where the second signal S2a is present. Similarly, if the second signal S2b is present in the predetermined time period Tp before the first signal S1b, the time interval T1b between the first signal S1b and the second signal S2b is recorded to form the first time parameter. In addition, when one second signal corresponding to the first signal S1c is not present in the predetermined time period Tp before the first signal S1c, recording it as a packet loss and recording a position of the first signal S1c in the time sequence (i.e., time point t1c) to form the second time parameter. And, a relationship could be further established with respect to the packet loss to determine a correlation between the packet loss and the first signal S1c.

The aforementioned predetermined time period Tp could be determined by the user. The advantage of customizing the predetermined time period Tp is that the user could determine the device under test 10 would be recognized as functioning properly when one second signal corresponding to the first signal is present in the predetermined time period Tp customized. When one second signal is not present in the predetermined time period Tp before the first signal, it indicates that a fault may be present in the device under test 10 or there could be a bad connection between the device under test 10 and the analyzer 20, and the user could perform troubleshooting based on the faults.

In addition, the aforementioned pairing analysis step of step S142 further includes: counting, by the electronic device 30, the number of first signals S1a, S1b, S1c and the number of second signals S2a, S2b, S2c, counting the distribution of the time intervals of the second signals S2a, S2b, S2c and the corresponding first signals S1a, S1b, S1c and counting the number of packet loss and output packet loss.

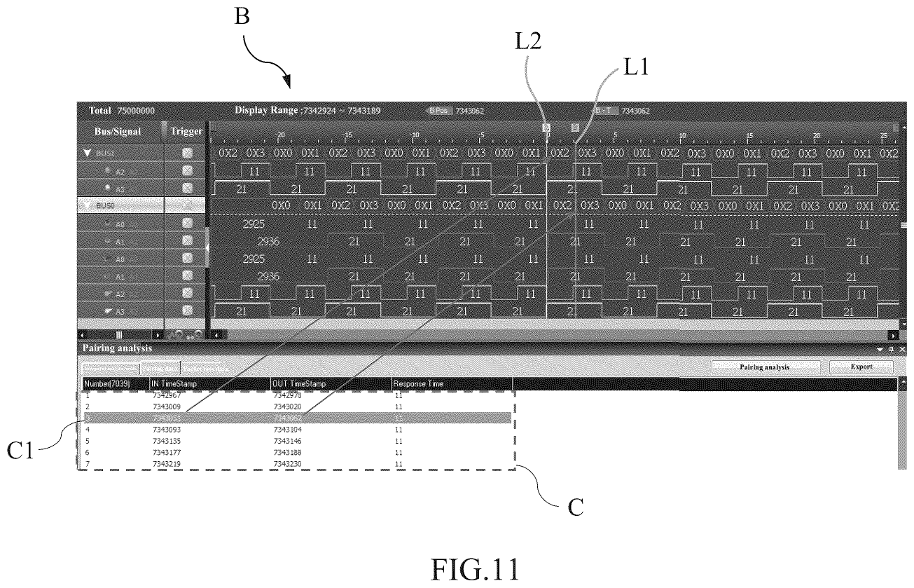

As shown in FIG. 11, after the pairing analysis step, a pairing data list C could be obtained. The pairing data list C includes a plurality of sets of pairing data and each set of pairing data has one first signal and one second signal. The pairing data list C would be displayed on the display interface B1; for example, FIG. 11 exemplifies the pairing data list C, including the first to seventh set of pairing data, each set of pairing data including the timestamp of the first signal, the timestamp of the second signal, and the response time. The user could click on each set of pairing data; for example, when clicking on a set of pairing data C1, the electronic device 30 uses the timestamps to mark a position of one output signal corresponding to the first signal in the set of pairing data C1 and to mark a position of one input signal corresponding to the second signal in the set of pairing data C1, thereby informing the user of the position of the second signal among the input signals and the position of the first signal among the output signals. For example, in the current embodiment, moving marked lines L1, L2 are present at the positions corresponding to the input signals and the output signals on the display interface B, wherein the intersection of the moving marked line L1 and one of the output signals marks the position of the first signal while the intersection of the moving marked line L2 and one of the input signals marks the position of the second signal. With the aforementioned design, the user could quickly intuitively identify the positions of the first signals and the second signals corresponding to each set of pairing data and the relationship of corresponding time sequence.

In addition, after the aforementioned pairing analysis step, a packet loss data list could be obtained when a packet loss is present, the packet data loss data list including a plurality of sets of packet loss data of the plurality of packet loss. Similarly, the packet loss data list could be displayed on the display interface B. The user could click on any set of packet loss data and a position of one output signal corresponding to the set of packet loss data clicked would be marked on the display interface B, thereby informing the user of the position of the output signal corresponding to the first signal of the packet loss data. With the aforementioned design, the user could quickly intuitively identify the position of the first signal, which corresponds to the set of packet loss data clicked, and the relationship of corresponding time sequence.

When an output packet loss is present, an output packet loss data list could be obtained, the output packet loss data list including a plurality of sets of output packet loss data of the plurality of output packet loss. Similarly, the output packet loss data list could be displayed on the display interface B. The user could click on any set of output packet loss data and a position of one output signal corresponding to the set of output packet loss data clicked would be marked on the display interface B, thereby informing the user of the position of the output signal corresponding to the set of output packet loss data clicked. With the aforementioned design, the user could quickly intuitively identify the position of the first signal, which corresponds to the set of output packet loss data clicked, and the relationship of corresponding time sequence.

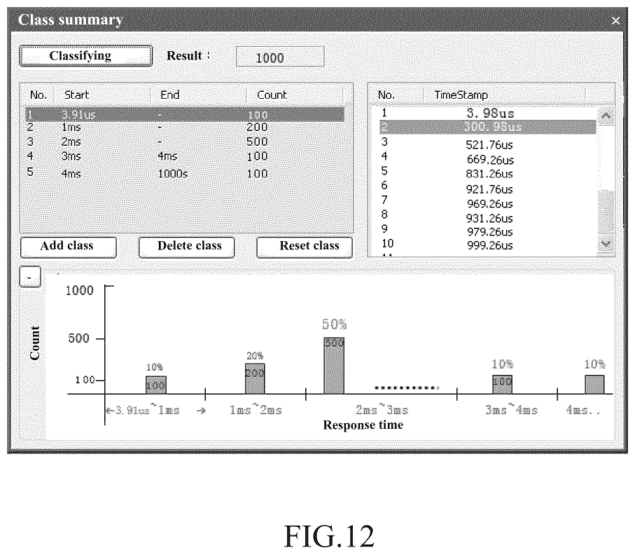

The pairing analysis step further includes counting the time interval between each first signal and the corresponding second signal to obtain the time difference between each output signal and the corresponding input signal of the device under test 10. For example, in the current embodiment, when taking the quality inspection equipment as an example, the time difference represents a response time required by the quality inspection equipment to perform each inspection. By comparing the differences in response times between inspections, statistical results for the ratios and bar charts of each time segment in the response times required by the quality inspection equipment to perform each inspection could be produced. As the exemplified statistical results shown in FIG. 12, the user could view the distribution of time required for each inspection based on the statistical results.

The statistical results could be classified automatically by the electronic device 30, i.e., be divided into multiple time segments, e.g. five to ten time segments, based on the maximum and minimum values of all the response time, and all the response times are classified into the time segments. Taking FIG. 12 as an example, the majority of the response times required by the quality inspection equipment are between 2 ms and 3 ms. With the information, the user could assess the operation of the quality inspection equipment (i.e., the device under test 10) based on the statistical results. The user could also inspect and analyze the reasons for the response times that occur primarily in the specific time segment, thereby facilitating improvements or optimizations in the performance of the quality inspection equipment. Additionally, the user could customize each time segment, and the electronic device 30 classifies all the response times into the time segments customized by the user. When clicking on “Reset class”, the classification would revert to automatic mode.

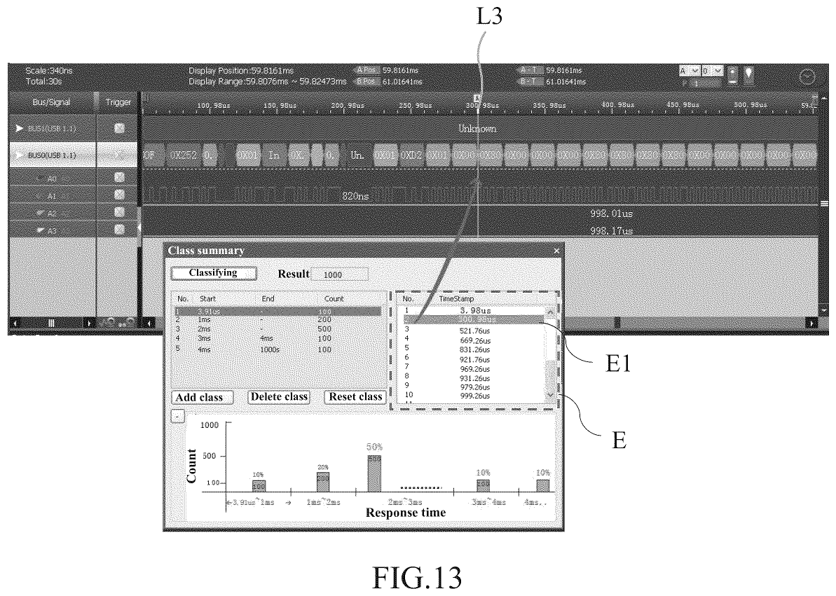

In addition, as shown in FIG. 13, a display table E displayed in the statistical result shows a plurality of sets of response time data E1 in each time segment. For example, each set of response time data E1 includes a timestamp and a response time (not shown in FIG. 13). When the user clicks on a set of response time data E1, the electronic device 30 would use the timestamp to simultaneously mark a position of the output signal corresponding to the set of response time data E1 on the display interface of the display device 40, thereby informing the user of the positions of the output signals corresponding to the first signal of the set of response time data E1. For example, the position of the first signal is marked with a moving marked line L3. In this way, when any set of response time data is found to be abnormal, the user could intuitively click on the set of response time data and the electronic device 30 could use the timestamp to quickly locate the position of the first signal corresponding to the output signal of the set of response time data. Alternatively, the electronic device 30 could mark the position of the input signal corresponding to any set of response time data clicked for the user to quickly find the position of the second signal corresponding to the input signal of the set of response time data.

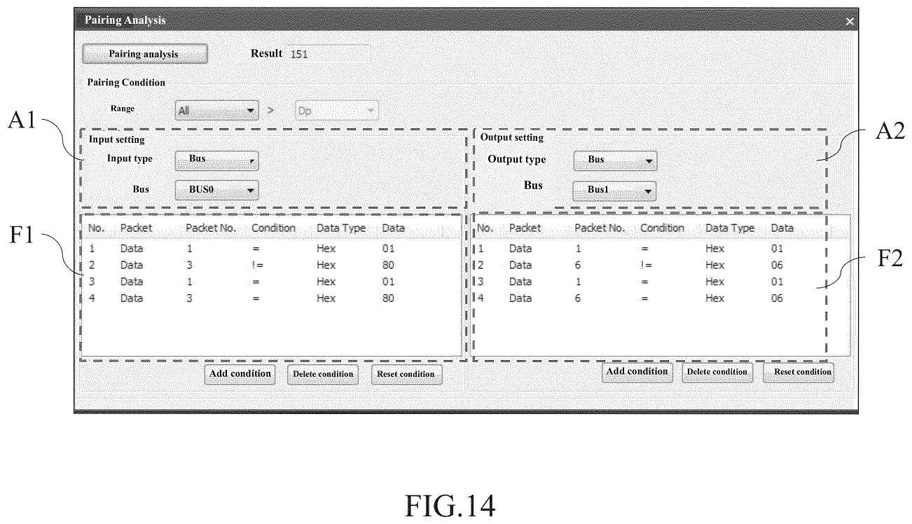

In addition, in a second embodiment of the present invention, the setting step of step S12 is slightly different from the setting step of step S12 the first embodiment. As shown in FIG. 14, when the user selects the type of bus packet in the input setting area A1 and output setting area A2 in the setting step, the electronic device 30 would provide a packet list F1 of the input signals and a packet list F2 of the output signals. The packet list F1 lists the bus packets captured from the input signals in the signal file while the packet list F2 lists the bus packets captured from the output signals in the signal file. The user could select at least one bus packet from the packet lists F1, F2, and the electronic device 30 uses the at least one bus packet selected by the user from the packet lists F1, F2 to respectively generate the input signal search condition or the output signal search condition. After the user sets the input signal search condition or the output signal search condition, the electronic device 30 could proceed to the search step of step S13 and the pairing analysis step of step S14, which are the same as in the first embodiment and would be not repeated herein.

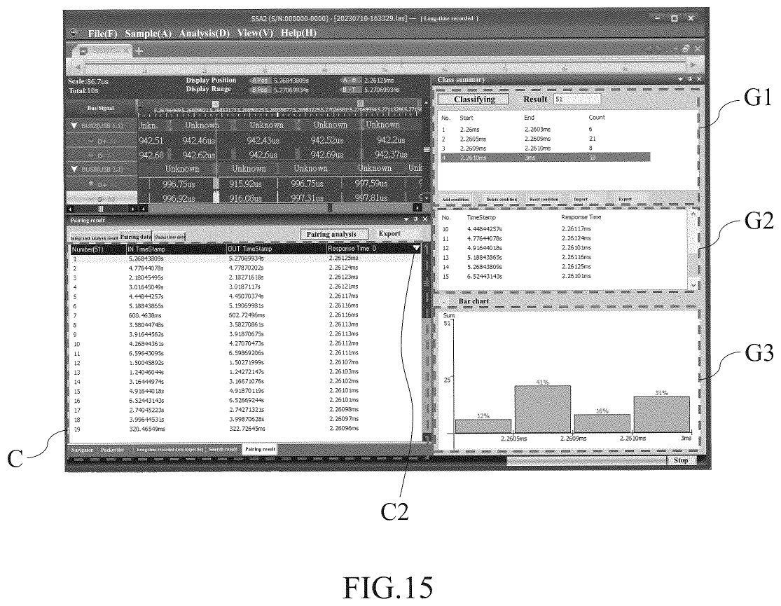

As shown in FIG. 15, a third embodiment according to the present invention is almost the same as the first embodiment, except that the display interface B in the third embodiment includes the pairing data list C and the statistical results.

A sort tab is provided in the pairing data list C. The user could click on the sort tab to perform an ascending sort, a descending sort, or to retain the original pairing results without sorting (i.e., to display based on the original pairing results) for the response time in the pairing data list C.

The statistical results include three display tables G1, G2, G3. The display table G1 shows classified results of all the response times. The electronic device 30 could automatically classifies all the response times into a plurality of time segments or classifies into a plurality of user-defined time segments. The user could also export or import the plurality of time segments customized to save the user's time for setting, i.e., export the start time and end time of each time segment to a setting file or import the start time and end time of each time segment from a setting file. When clicking on “Reset class”, the classification would revert to automatic mode.

The display table G2 shows a plurality of sets of response time data of each time segment, each set of response time data including a timestamp and a response time. When the user clicks on any time segment on the display table G1, the sets of response time data of the time segment clicked is displayed on the display table G2. The display table 3 is a bar graph showing the number and ratios of the response time of each time segment.

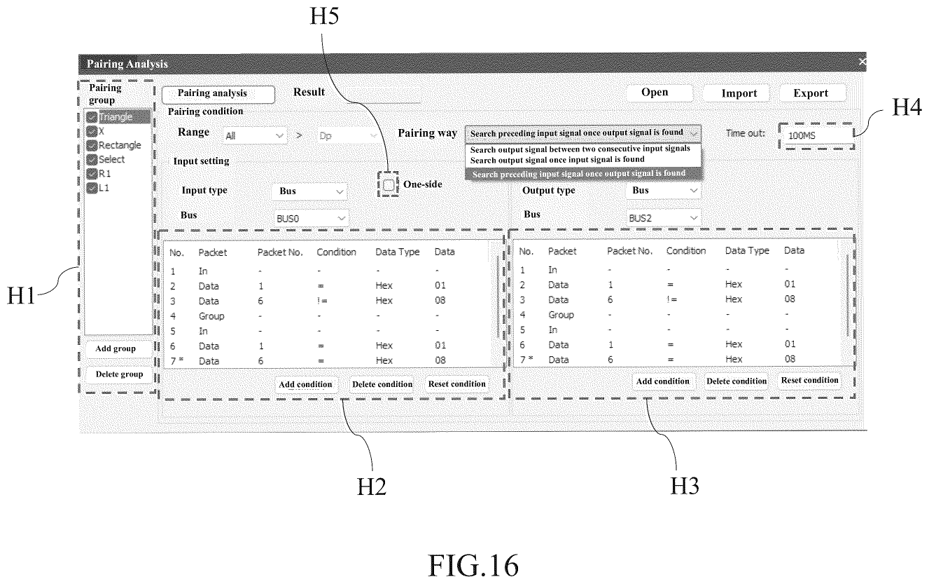

As shown in FIG. 16, a fourth embodiment according to the present invention is almost the same as the first embodiment, except that:
the setting step of step S12 includes setting a plurality of pairing groups, whose names are displayed on a display table H1. In the setting step, a search condition for input signals to be searched and a search condition for output signals to be searched for each pairing group could be set to respectively generate an input signal search condition and an output signal search condition. As shown in FIG. 16, the types of the input signals and the output signals for each pairing group could be selected as waveform signals or bus packet signals. Taking the bus packet signals as an example, the electronic device 30 provides a packet list H2 of input signals and a packet list H3 of output signals. The user selects at least one bus packet from the packet lists H2, H3, and the electronic device 30 uses the at least one bus packet selected by the user from the packet lists H2, H3 to respectively generate the input signal search condition or the output signal search condition for each pairing group. The user could switch the pairing group desired to set the input signal search condition and output signal search condition.

Additionally, the user could export the input signal search conditions and output signal search conditions for one or more pairing groups to a setting file or import the input signal search conditions and output signal search conditions for one or more pairing groups from a setting file.

In the search step of step S13, the electronic device 30 performs a search among the output signals in the signal file to find the first signals that match the output signal search condition for each pairing group based on the output signal search condition for each pairing group, and performs a search among the input signals in the signal file to find the second signals that match the input signal search condition for each pairing group based on the input signal search condition for each pairing group.

In the pairing analysis step of step S14, step S141 and step S142 are performed for each pairing group to generate statistical results for each pairing group. The specific steps for performing step S141 could be the flow chart shown in FIG. 10, and the user could enter the predetermined time period customized in an input box H4 in FIG. 16.

The user could customize the start reference time point in the packet list H2 of input signals; for example, when the user clicks on the number 7 to set the start reference time point, the symbol “*” would be displayed next to the number “7” to represent the start reference time point. The user could also customize the end reference time point in the packet list H3 of output signals; for example, when the user clicks on the number “7” to set the end reference time point, the symbol “*” would be displayed next to the number “7” to represent the end reference time point. The time interval in step S141 is the time difference between the start reference time point and the end reference time point.

In addition, a checkbox H5 is provided for the user to select whether to include a time interval between the occurrence of a periodic signal in the statistical result.

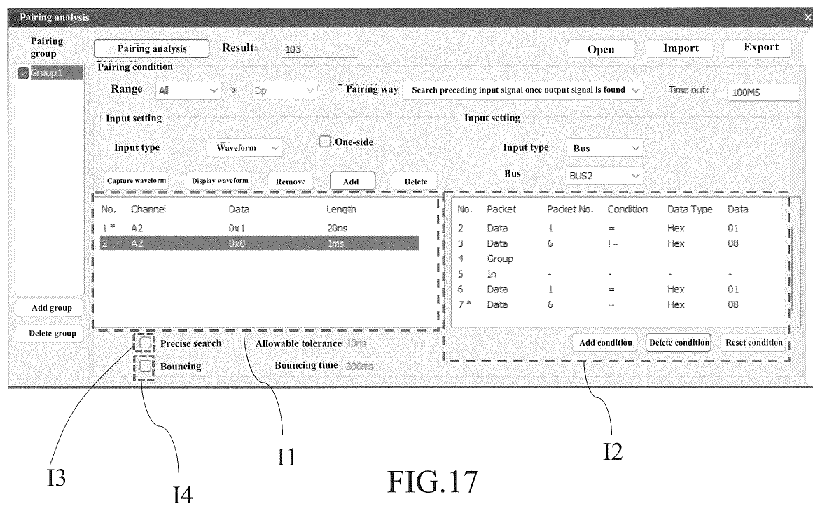

As shown in FIG. 17, a fifth embodiment according to the present invention is almost the same as the fourth embodiment, except that:

One pairing group is set in the setting step of step S12 and the type of the input signal of the pairing group is waveform signal. In the list I1, the user could customize the start reference time point of the input signal, which is displayed with the symbol “*” The type of the output signal is bus packet signal, and in the packet list 12, the user could also customize the end reference time point of the output signal, which is displayed with the symbol “*”

In addition, a checkbox 13 is provided for the user to select whether or not to use noise filtering. After the checkbox 13 is checked, the electronic device 30 activates the function of noise filtering and sets a tolerance time for the input signal to be searched. The tolerance time, such as 10 ns, is set by default or is set by the user with “Allowable tolerance”, i.e., in the search step of step S13, the input signal whose duration is less than the tolerance time (10 ns) is ignored and does not form the second signal. A checkbox 14 is provided for the user to select whether to use debouncing. After the checkbox 14 is checked, the electronic device 30 activates the function of debouncing and sets a bouncing time for the input signals to be searched. The bouncing time, such as 300 ms, is set by default or is set by the user within “Bouncing time”. In the search step of step S13, the input signal whose duration is greater than the bouncing time and matches the input signal search condition forms the second signal, thereby ignoring the bounce of the input signal in the bouncing time. For example, the checkbox 13 and checkbox 14 could be used in the case of the input signals generated by at least one push button switch.

In each of the abovementioned embodiments, the statistical result could also include a maximum value, a minimum value, an average value of the response time, and the number and ratio of the packet loss. The electronic device 30 could export the statistical result to a file and export the packet loss data list to another file.

Additionally, in other embodiments, the device under test of the present invention is not limited to the quality inspection equipment, but could also be other hardware, devices, systems or working machines in production lines. For example, when the devices under test are working machines at different sites, the input signals could be the data when an object (e.g. raw material, semi-finished product, finished product) enters the site while the output signals could be the data when the object exits the site, wherein the data may include, without limitation, the production history of the object, or the time of entering and exiting the site of the object. With the abovementioned signal paring analysis method, the working conditions of the working machines at each site could be effectively evaluated. For example, the signal paring analysis method of the present invention could quickly identify issues such as abnormal delays or quality deterioration at any site for the user to effectively utilize and improve the shortcomings, thereby enhancing the efficiency of devices, hardware, or systems and improving the smoothness of scheduling.

It must be pointed out that the embodiments described above are only some preferred embodiments of the present invention. All equivalent structures which employ the concepts disclosed in this specification and the appended claims should fall within the scope of the present invention.

What is claimed is:

1. A signal pairing analysis method for analyzing a device under test that receives an input signal and generates a corresponding output signal, comprising steps of:
loading, by an electronic device, a signal file to be analyzed, in which a plurality of input signals and a plurality of output signals captured from the device under test are recorded;
performing, by the electronic device, a setting step, including setting a search condition for the input signals to be searched and a search condition for the output signals to be searched, and respectively generating an input signal search condition and an output signal search condition accordingly;
performing, by the electronic device, a search step, including: searching among the plurality of output signals in the signal file to find a plurality of first signals that match the output signal search condition based on the output signal search condition, and searching among the plurality of input signals in the signal file to find a plurality of second signals that match the input signal search condition based on the input signal search condition;
performing, by the electronic device, a pairing analysis step, including:
A1. when any of the plurality of first signals is found to be preceded by one corresponding second signal, recording a first time parameter between the first signal and the corresponding second signal thereof;
A2. at least analyzing the plurality of first signals, the plurality of second signals and the plurality of first time parameters to generate a statistical result.

2. The signal pairing analysis method as claimed in claim 1, wherein step A1 of the pairing analysis step includes: when any of the plurality of first signals is not found to be preceded by one corresponding second signal, recording it as a packet loss and recording a second time parameter corresponding to the packet loss;
wherein, in step A2, the plurality of first signals, the plurality of second signals, the plurality of first time parameters and the plurality of second time parameters are analyzed to generate the statistical result.

3. The signal pairing analysis method as claimed in claim 2, wherein, in step A1 of the pairing analysis step, whether one second signal is present in a time period between two adjacent first signals is searched; if so, each of the first time parameters recorded is a time interval between the second signal and the first signal, which is present after the second signal in a time sequence; if not, each of the second time parameters recorded is a position of the first signal corresponding to the packet loss in the time sequence.

4. The signal pairing analysis method as claimed in claim 3, wherein, in step A1 of the pairing analysis step, an output packet loss is recorded and a third time parameter corresponding to the output packet loss is recorded when two or more second signals are found in the time period between two adjacent first signals.

5. The signal pairing analysis method as claimed in claim 3, wherein step A1 of the pairing analysis step further includes searching whether one second signal is present in a predetermined time period before the first signal, which is the first among the first signals in the time sequence; when one second signal is present in a predetermined time period before the first signal, which is the first among the first signals in the time sequence, a time interval between the first signal, which is the first among the first signals in the time sequence, and the corresponding second signal is recorded to form another first time parameters.

6. The signal pairing analysis method as claimed in claim 2, wherein, in step A1 of the pairing analysis step, whether one second signal is present in a predetermined time period before each of the first signals is searched; if so, each of the first time parameters recorded is a time interval between the second signal and the corresponding first signal; if not, each of the second time parameters recorded is a position of the first signal corresponding to the packet loss in the time sequence.

7. The signal pairing analysis method as claimed in claim 3, wherein the time interval is a time difference between a time point, at which the first signal presents, and another time point, at which the second signal presents.

8. The signal pairing analysis method as claimed in claim 6, wherein the time interval is a time difference between a time point, at which the first signal is present, and another time point, at which the second signal is present.

9. The signal pairing analysis method as claimed in claim 3, wherein the setting step includes setting a start reference time point of the input signal to be searched and an end reference time point of the output signal to be searched; in step A1, the time interval is a time difference between the start reference time point and the end reference time point.

10. The signal pairing analysis method as claimed in claim 6, wherein the setting step includes setting a start reference time point of the input signal to be searched and an end reference time point of the output signal to be searched; in step A1, the time interval is a time difference between the start reference time point and the end reference time point.

11. The signal pairing analysis method as claimed in claim 6, wherein the setting step includes setting a plurality of pairing groups; wherein, in the setting step, the search condition for the input signals to be searched and the search condition for the output signals to be searched for each pairing group are set to respectively generate the input signal search condition and the output signal search condition for each pairing group;
wherein, in the search step, based on the output signal search condition for each pairing group, the plurality of output signals in the signal file are searched to find the plurality of first signals that match the output signal search condition for each pairing group, and based on the input signal search condition for each pairing group, the plurality of input signals in the signal file are searched to find the plurality of second signals that match the input signal search condition for each pairing group;
wherein, in the pairing analysis step, step A1 and step A2 are performed for each pairing group to generate the statistical result for each pairing group.

12. The signal pairing analysis method as claimed in claim 1, wherein the setting step includes setting a tolerance time for the input signals to be searched; the search step includes ignoring any of the input signals whose duration is less than the tolerance time.

13. The signal pairing analysis method as claimed in claim 1, wherein the setting step includes setting a bouncing time for the input signals to be searched; wherein, in the search step, each of the second signals is one input signal whose duration is greater than the bouncing time and matches the input signal search condition.
